(19) United States
(12) Patent Application Publication
(10) Pub. No.: US 2023/0401828 A1
(43) Pub. Date: Dec. 14, 2023

(54) METHOD FOR TRAINING IMAGE RECOGNITION MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Meina QIAO, Bejing (CN); Shanshan LIU, Beijing (CN); Xiameng QIN, Beijing (CN); Chengquan ZHANG, Beijing (CN); Kun YAO, Beijing (CN)

(21) Appl. No.: 17/905,965

(22) PCT Filed: Apr. 8, 2022
(86) PCT No.: PCT/CN2022/085915

§ 371 Date: Sep. 9, 2022

(30) Foreign Application Priority Data
Aug. 13, 2021 (CN) 202110934322.3

(51) Int. Cl. G06V 10/774; G06V 30/14; G06V 10/764

(52) U.S. Cl. CPC G06V 10/774; G06V 10/764; G06V 30/1444

(57) ABSTRACT

A method for training an image recognition model includes: obtaining a training data set, in which the training data set includes first text images of each vertical category in a non-target scene and second text images of each vertical category in a target scene, and a type of text content involved in the first text images is the same as a type of text content involved in the second text image; training an initial recognition model by using the first text images, to obtain a basic recognition model; and modifying the basic recognition model by using the second text images, to obtain an image recognition model corresponding to the target scene.

### CROSS-REFERENCE OF RELATED APPLICATIONS

The present application is a U.S. national phase application of International Application No. PCT/CN2022/085915 filed on Apr. 8, 2022, which claims priority to Chinese Patent Application No. 202010023053.0 filed on Aug. 13, 2021, the entire disclosures of which are incorporated herein by reference.

### TECHNICAL FIELD

The disclosure relates to the field of computer technologies, especially the field of Artificial Intelligence (AI) technologies such as computer vision and deep learning, in particular to a method for training an image recognition model, an apparatus for training an image recognition model, a device, a storage medium and a computer program product.

### BACKGROUND

With the continuous development and improvement of AI technologies, AI technologies have played an extremely important role in various fields of daily life. For example, it is convenient for information collection and processing when Optical Character Recognition (OCR) technology is used to extract text information from scenes such as files, books and scanned copies.

### SUMMARY

According to a first aspect of the disclosure, a method for training an image recognition model is provided. The method includes: obtaining a training data set, in which the training data set includes first text images of each vertical category in a non-target scene and second text images of each vertical category in a target scene, and a type of text content involved in the first text images is the same as a type of text content involved in the second text images; training an initial recognition model by using the first text images, to obtain a basic recognition model; and modifying the basic recognition model by using the second text images, to obtain an image recognition model corresponding to the target scene.

According to a second aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is enabled to implement a method for training an image recognition model. The method includes: obtaining a training data set, in which the training data set includes first text images of each vertical category in a non-target scene and second text images of each vertical category in a target scene, and a type of text content involved in the first text images is the same as a type of text content involved in the second text images; training an initial recognition model by using the first text images, to obtain a basic recognition model; and modifying the basic recognition model by using the second text images, to obtain an image recognition model corresponding to the target scene.

According to a third aspect of the disclosure, a non-transitory computer-readable storage medium having computer instructions stored thereon is provided. The computer instructions are configured to cause a computer to implement a method for training an image recognition model. The method includes: obtaining a training data set, in which the training data set includes first text images of each vertical category in a non-target scene and second text images of each vertical category in a target scene, and a type of text content involved in the first text images is the same as a type of text content involved in the second text images; training an initial recognition model by using the first text images, to obtain a basic recognition model; and modifying the basic recognition model by using the second text images, to obtain an image recognition model corresponding to the target scene.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure.

FIG. 1 is a flowchart of a method for training an image recognition model according to an embodiment of the disclosure.

FIG. 2 is a flowchart of a method for training an image recognition model according to another embodiment of the disclosure.

FIG. 3 is a schematic diagram of an apparatus for training an image recognition model according to an embodiment of the disclosure.

FIG. 4 is a schematic diagram of an apparatus for training an image recognition model according to another embodiment of the disclosure.

FIG. 5 is a block diagram of an electronic device used to implement the method for training an image recognition model according to the embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications may be made to the embodiments described herein without departing from the scope of the disclosure. For clarity and conciseness, descriptions of well-known functions and structures are omitted in the following description.

In order to facilitate the understanding of the disclosure, a brief description of the technical field to which the present disclosure relates will be briefly explained below.

AI is a subject that causes computers to simulate certain thinking processes and intelligent behaviors (such as learning, reasoning, thinking and planning) of human beings, which covers both hardware-level technologies and software-level technologies. The AI hardware technologies generally include technologies such as sensors, dedicated AI chips, cloud computing, distributed storage, and big data processing. The AI software technologies generally include several major aspects such as computer vision technology, speech recognition technology, natural language processing technology, machine learning/deep learning, big data processing technology and knowledge graph technology.

Deep Learning (DL) is to learn internal laws and representation levels of sample data. The information obtained in the learning process is of great help to interpretation of data such as text, images and sounds. The ultimate goal of DL is to enable machines to have an ability to analyze and learn like humans, have an ability to recognize data such as text, images and sounds. DL is a complex machine learning algorithm that has achieved results in speech and image recognition far exceeding previous related art.

Computer vision is an interdisciplinary scientific field that studies how to enable computers to gain a high level of understanding from digital images or videos. From an engineering perspective, it seeks automate tasks that may be accomplished by human visual system. Computer vision tasks include methods of acquiring, processing, analyzing and understanding digital images, as well as methods for extracting high-dimensional data from the real world in order to produce numerical or symbolic information, for example, in the form of decisions.

However, for specific vertical categories in specific scenarios such as certificates and bills/invoices, the recognition accuracy of the trained OCR model is not high due to the limited amount of training data that may be obtained. Therefore, how to improve the recognition accuracy of OCR for different vertical categories in specific scenarios is of great significance.

The disclosure provides a method for training an image recognition model. The method may be implemented by an apparatus for training an image recognition model of the disclosure, or by an electronic device of the disclosure. The electronic device may include but not limited to a server and a terminal device such as a mobile phone, a desktop computer and a tablet computer. The method for training an image recognition model of the disclosure is implemented by the apparatus for training an image recognition model of the disclosure, hereinafter referred to simply as “apparatus”, which is not limited in the disclosure.

A method for training an image recognition model, an apparatus for training an image recognition model, a device, a storage medium and a computer program product according to the disclosure will be described in detail below with reference to the accompanying drawings.

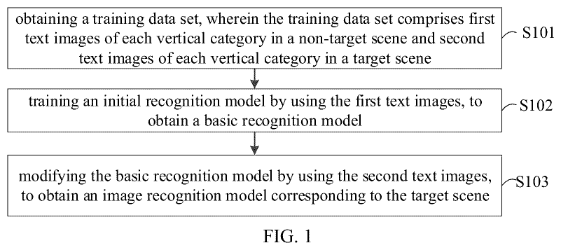

FIG. 1 is a flowchart of a method for training an image recognition model according to an embodiment of the disclosure.

As illustrated in FIG. 1, the method for training an image recognition model includes the following steps at S101-S103.

At S101, a training data set is obtained, in which the training data set includes first text images of each vertical category in a non-target scene and second text images of each vertical category in a target scene, and a type of text content involved in the first text images is the same as a type of text content involved in the second text images.

The target scene may be any specified scene. It may be understood that the target scene may have certain attributes or characteristics, and each kind of text images that needs to be recognized in the target scene may belong to a kind of vertical category.

For example, the target scene may be a traffic scene, and the text images of each vertical category in the traffic scene may include: vehicle license text images, driving license text images and vehicle quality certificate text images, which are not limited herein.

Alternatively, the target scene may be a financial scene. The text images of each vertical category in this financial scene may include: value-added tax (VAT) invoice text images, machine-printed invoice text images, itinerary text images, bank check text images, bank receipt text images, which are not limited here.

The non-target scene may be a scene similar to the target scene, or a scene that is intrinsically related to the target scene. For example, the text images of each vertical category in the target scene and the text images of each vertical category in the non-target scene contain the same type of text content.

For example, when the current target scene is a traffic scene, the non-target scene may be an identity document scene. It should be noted that, in the document scene, the text images to be recognized are usually ones of ID cards and passports. The text images of ID cards and passports, and the text images of vehicle licenses, driving licenses and vehicle quality certificates both contain text types such as text, date, and license number. Therefore, the text images in the document scene may be used as the first text images, that is, the text images corresponding to the non-target scene, which is not limited here.

It should be noted that the first text images and the second text images included in the training data set may be images obtained by image sensors such as a webcam and a camera, and the images may be color images or gray images, which are not limited herein. In addition, data synthesis and data augmentation may also be performed on the text data in the training data set, to augment the diversity of the training data, which is not limited herein.

At S102, an initial recognition model is trained by using the first text images, to obtain a basic recognition model.

The initial recognition model may be an initial deep learning network model that has not been trained, and the basic recognition model may be a network model generated in the process of training the initial recognition model with the first text images, i.e., the training data.

In some examples, the first text images, that is, the training data, may be input into the initial recognition model in batches according to preset parameters, and differences between the text data in the text images extracted/recognized by the initial recognition model and real text data corresponding to the text images are determined based on an error function of the initial recognition model. Then, back propagation training is performed on the initial recognition model based on the error, to obtain the basic recognition model.

It should be noted that, there may be 8,000 or 10,000 first text images used for training the initial recognition model, which is not limited herein.

Optionally, in some embodiments, the initial recognition model may be a network model such as a Convolutional Recurrent Neural Network (CRNN) and an attention mechanism, which is not limited herein.

At S103, the basic recognition model is modified by using the second text images, to obtain an image recognition model corresponding to the target scene.

It should be noted that, after the basic recognition model is determined, the basic recognition model is modified by using the second text images corresponding to the target scene as the training data, to obtain the image recognition model corresponding to the target scene.

In some examples, the second text images, i.e., the training data, may be input into the basic recognition model in batches according to preset parameters. Then, differences between the text data in the text images extracted by the basic recognition model and the real text data corresponding to the text images are determined according to an error function of the basic recognition model. Based on the error, back propagation training is performed on the basic recognition model to obtain the image recognition model corresponding to the target scene.

Optionally, the training data set may also include text images in any scene, for example, text images of documents, books and scanned copies, which are not limited herein. When the basic recognition model is obtained by training, both the text images in any scene and the first text images may be used together as the training data. Correspondingly, when the image recognition model corresponding to the target scene is obtained by training, both the text images in any scene and the second text images may be used together as the training data.

It should be noted that, it is difficult to collect a sufficient amount of training data due to the private nature of text images in specific scenes. The text images in any scene contain a large amount of text information, which may make up for the shortage of insufficient number of text images of different vertical categories in both the target scene and non-target scene. Therefore, when the text images in any scene are added to the training data set, the amount of training data is increased and the basic recognition ability of the image recognition model is thus improved.

In the embodiment of the disclosure, the training data set is obtained, in which the training data set includes the first text images of each vertical category in the non-target scene, and the second text images of each vertical category in the target scene. The type of text content involved in the first text images is the same as the type of text content involved in the second text images. The basic recognition model is obtained by training the initial recognition model by using the first text images. The image recognition model corresponding to the target scene is obtained by training the basic recognition model by using the second text images. Therefore, when the image recognition model in the target scene is obtained by training, a recognition model that may be applied to different vertical categories of the target scene, is obtained by training with text images of different vertical categories of a scenes similar to the target scene, and text images of different vertical categories in the target scene, which improves the recognition accuracy and versatility of the model, reduces the memory occupied by the model, and saves labor costs and material costs.

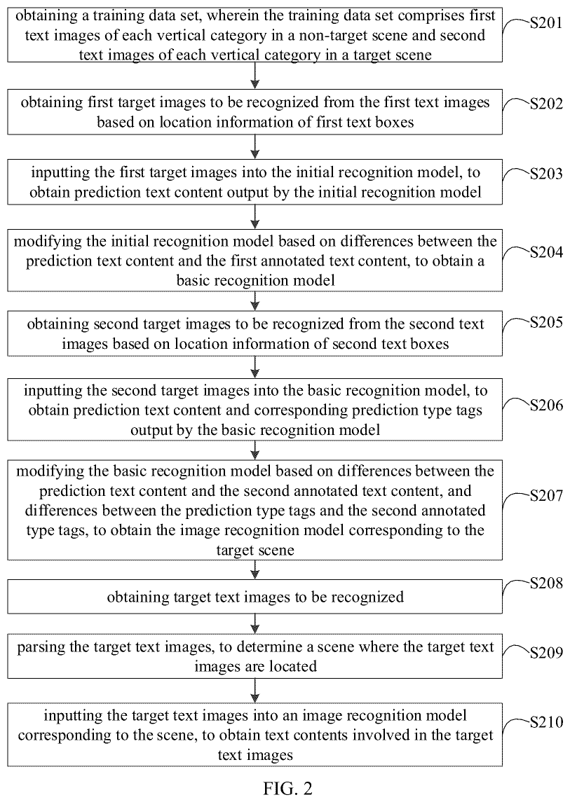

FIG. 2 is a flowchart of a method for training an image recognition model according to another embodiment of the disclosure.

As illustrated in FIG. 2, the method for training an image recognition model includes the following steps at S201-S210.

At block S201, a training data set is obtained, in which the training data set includes first text images of each vertical category in a non-target scene and second text images of each vertical category in a target scene, and a type of text content involved in the first text images is the same as a type of text content involved in the second text images.

It should be noted that, for the specific implementation process of step S201, reference may be made to the foregoing embodiments, and details are not described herein.

Optionally, the training data set may include: for each of the first text images, first annotated text content, location information of first text boxes, and first annotated type tags corresponding to the first annotated text content.

It should be noted that, for each of the collected first text images, the text content may be annotated, and the location information of the text boxes may be determined at the same time, and the corresponding type tags for the first annotated text content may also be determined, and then the first text images are added to the training data set. The first annotated text content may include the texts contained in the first text images.

For example, when the current first text image is a VAT invoice text image, the corresponding first annotated text content may include pieces of text information, such as the buyer's name, identification number of taxpayer, invoice date and tax. The first text boxes may be determined based on pieces of text information included in the first annotated text content. The first annotated type tags may include the type annotated on each of the first text boxes. For example, “date” may be annotated in a first text box for the invoice date, “number” may be annotated in a first text box for the identification number of taxpayer, and “amount” may be annotated in a first text box for the tax amount, which are not limited here.

In detail, after the first text boxes are determined, locations of the first text boxes may be determined, and the location information of the first text boxes may be determined. For example, the coordinates of the first text boxes may be used as the location information of the first text boxes, which is not limited herein.

At S202, first target images to be recognized are obtained from the first text images based on the location information of first text boxes.

It should be noted that the location information of the first target images to be recognized may be determined according to the location information of the first text boxes, and the images to be recognized, i.e., the first target images, are determined from the first text images according to the locations.

In the embodiment of the disclosure, the location information of text boxes is determined, and then the target images to be recognized are determined from the text images according to the location information, to avoid identifying blank areas and improving the training efficiency of the recognition model.

At S203, the first target images are input into the initial recognition model, to obtain prediction text content output by the initial recognition model.

Optionally, the first target images may be input into the initial recognition model to obtain the prediction text content and the prediction type tags output by the initial recognition model. During the training process, target images may be continuously added for training.

At S204, the initial recognition model is modified based on differences between the prediction text content and the first annotated text content, to obtain the basic recognition model.

The distances between each pixel in the prediction text content and the corresponding pixel in the first annotated text content may be determined at first, and these distances may represent the differences between the prediction text content and the first annotated text content.

For example, the Euclidean distance formula, or the Manhattan distance formula, may be used to determine the distances between each pixel in the prediction text content and the corresponding pixel in the first annotated text content, to further determine a correction gradient, and the initial recognition model may be modified based on the correction gradient, which is not limited here.

Optionally, the initial recognition model may also be modified based on the differences between the prediction text content and the first annotated text content, and differences between the prediction type tags and the first annotated type tags, to obtain the basic recognition model.

For example, the initial recognition model may be modified according to the differences between the prediction text content and the first annotated text content at first, and then modified according to the differences between the prediction type tags and the first annotated type tags.

Alternatively, the initial recognition model may be modified according to the differences between the prediction type tags and the first annotated type tags firstly, and then modified according to the differences between the prediction text content and the first annotated text content.

Alternatively, the initial recognition model may be modified according to the differences between the prediction text content and the first annotated text content, and the differences between the prediction type tags and the first annotated type tags simultaneously, to obtain the basic recognition model.

In the embodiment of the disclosure, by training the recognition model to output the prediction text content and the prediction type tags at the same time, the recognition model may automatically annotate the information type of the recognized text during operation, which makes it convenience for subsequent processing of information.

Optionally, the training data set may further include for each of the second text images, second annotated text content, location information of second text boxes, and second annotated type tags corresponding to the second annotated text content.

It should be noted that, specific examples of the second annotated text content, the location information of the second text boxes and the second annotated type tags, may refer to the above-mentioned first annotated text content, the location information of first text boxes and the first annotated type tags corresponding to the first annotated text content, which will not be repeated here.

At S205, second target images to be recognized are obtained from the second text images based on the location information of second text boxes.

It should be noted that the locations of second target images to be recognized may be determined according to the location information of second text boxes, and then the images to be recognized, i.e., the second target images, may be determined from the second text images according to the locations.

At S206, the second target images are input into the basic recognition model, to obtain prediction text content and corresponding prediction type tags output by the basic recognition model.

At S207, the basic recognition model is modified based on differences between the prediction text content and the second annotated text content, and differences between the prediction type tags and the second annotated type tags, to obtain the image recognition model corresponding to the target scene.

It should be noted that, for the specific implementation process of steps S205, S206 and S207, reference may be made to the above-mentioned steps S202, S203 and S204, which will not be repeated here.

At S208, target text images to be recognized are obtained.

It should be noted that the target text images, i.e., the designated images to be recognized, may be any text image, such as certificates and bills, which is not limited here.

It should be noted that the target text images may be images acquired by any image sensor, such as a webcam and a camera, and the images may be color images or gray images, which is not limited herein.

At S209, the target text images are parsed, to determine a scene where the target text images are located.

In the embodiment of the disclosure, the scene corresponding to the target text images may be determined by parsing the obtained target text images. For example, when the current target text image is a driving license text image, it may be determined that the current target text image belongs to a traffic scene. For example, when the current target text image is a VAT invoice image, it is determined that the target text image belongs to a financial scene, which is not limited here.

At S210, the target text images are input into an image recognition model corresponding to the scene, to obtain text content involved in the target text images.

After the scene to which the target text images belong is determined, the image recognition model corresponding to the scene may be determined. Furthermore, the target text images may be input into the image recognition model corresponding to the scene, so that the text content corresponding to the target text images may be output.

For example, when the target text image belongs to a driving license, it may be input into the image recognition model for the traffic scene.

Alternatively, when the target text image belongs to a VAT invoice, it may be input into an image recognition model for the financial scene.

In the embodiment of the disclosure, after the scene to which the target text images belong is determined, the image recognition model corresponding to the scene is used to identify the target text images, so that the reliability and accuracy of image recognition are improved.

In the embodiment of the disclosure, the training data set is obtained, and the training data set includes the first text images of each vertical category in the non-target scene, and the second text images of each vertical category in the target scene. The type of text content involved in the first text images is the same as the type of text content involved in the second text images. The basic recognition model is obtained by training the initial recognition model with the first text images. The image recognition model corresponding to the target scene is obtained by training the basic recognition model with the second text images. The target text images to be recognized are obtained. The target text images are parsed to determine the scene where the target text images are located. The target text images are input into the image recognition model corresponding to the scene, to obtain the text content involved in the target text images. When the basic recognition model is obtained by training, the initial recognition model is modified according to the differences between the prediction text content and the first annotated text content. When the image recognition model corresponding to the target scene is obtained by training, the basic recognition model is modified according to the differences between the prediction text content and the second annotated text content, and the differences between the prediction type tags and the second annotated type tags, so that the generated basic recognition model has high accuracy and great applicability, to accurately generate the corresponding text content according to the target text images.

According to the embodiment of the disclosure, the disclosure also provides an apparatus for training an image recognition model.

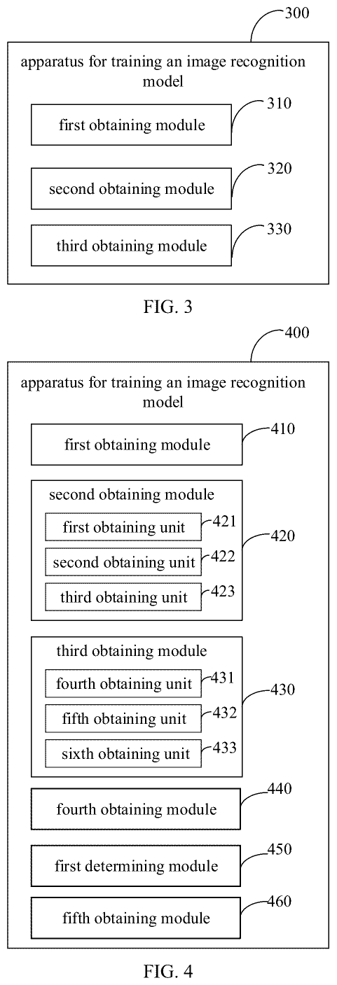

FIG. 3 is a schematic diagram of an apparatus for training an image recognition model according to the embodiment of the disclosure. As illustrated in FIG. 3, the apparatus for training an image recognition model 300 further includes: a first obtaining module 310, a second obtaining module 320 and a third obtaining module 330.

The first obtaining module 310 is configured to obtain a training data set. The training data set includes first text images of each vertical category in a non-target scene and second text images of each vertical category in a target scene, and a type of text content involved in the first text images is the same as a type of text content involved in the second text images.

The second obtaining module 320 is configured to train an initial recognition model by using the first text images, to obtain a basic recognition model.

The third obtaining module 330 is configured to modify the basic recognition model by using the second text images, to obtain an image recognition model corresponding to the target scene.

In a possible implementation of the embodiment of the disclosure, the training data set also includes text images in any scene.

In the embodiment of the disclosure, the training data set is obtained, and the training data set includes the first text images of each vertical category in the non-target scene, and the second text images of each vertical category in the target scene. The type of text content involved in the first text images is the same as the type of text content involved in the second text images. The basic recognition model is obtained by training the initial recognition model with the first text images. The image recognition model corresponding to the target scene is obtained by training the basic recognition model with the second text images. Therefore, when the image recognition model in the target scene is obtained by training, a recognition model that may be applied to different vertical categories of the target scene is obtained by training with text images of different vertical categories of a scenes similar to the target scene, and text images of different vertical categories in the target scene, which improves the recognition accuracy and versatility of the model, reduces the memory occupied by the model, and saves labor costs and material costs.

FIG. 4 is a schematic diagram of an apparatus for training an image recognition model according to the embodiment of the disclosure. As illustrated in FIG. 4, the apparatus 400 may include: a first obtaining module 410, a second obtaining module 420 and a third obtaining module 430.

In a possible implementation of the embodiment of the disclosure, the training data set further includes for each of the first text images, first annotated text content and location information of first text boxes.

The second obtaining module 420 further includes: a first obtaining unit 421, a second obtaining unit 422 and a third obtaining unit 423.

The first obtaining unit 421 is configured to obtain first target images to be recognized from the first text images based on the location information of the first text boxes.

The second obtaining unit 422 is configured to input the first target images into the initial recognition model, to obtain prediction text content output by the initial recognition model.

The third obtaining unit 423 is configured to modify the initial recognition model based on differences between the prediction text content and the first annotated text content, to obtain the basic recognition model.

In a possible implementation of the embodiment of the disclosure, the training data set further includes first annotated type tags corresponding to the first annotated text content.

The second obtaining unit 422 is further configured to input the first target images into the initial recognition model, to obtain the prediction text content and corresponding prediction type tags output by the initial recognition model.

The third obtaining unit 423 is further configured to modify the initial recognition model based on the differences between the prediction text content and the first annotated text content, and differences between the prediction type tags and the first annotated type tags, to obtain the basic recognition model.

In a possible implementation of the embodiment of the disclosure, the training data set further includes for each of the second text images, second annotated text content, location information of second text boxes, and second annotated type tags corresponding to the second annotated text content.

The third obtaining module 430 further includes: a fourth obtaining unit 431, a fifth obtaining unit 432 and a sixth obtaining unit 433.

The fourth obtaining unit 431 is configured to obtain second target images to be recognized from the second text images based on the location information of the second text boxes.

The fifth obtaining unit 432 is configured to input the second target images into the basic recognition model, to obtain prediction text content and corresponding prediction type tags output by the basic recognition model.

The sixth obtaining unit 433 is configured to modify the basic recognition model based on differences between the prediction text content and the second annotated text content, and differences between the prediction type tags and the second annotated type tags, to obtain the image recognition model corresponding to the target scene.

In a possible implementation of the embodiment of the disclosure, the training apparatus may further include a fourth obtaining module 440, a first determining module 450 and a fifth obtaining module 460.

The fourth obtaining unit 440 is configured to obtain second target images to be recognized from the second text images based on the location information of the second text boxes.

The fifth obtaining unit 450 is configured to input the second target images into the basic recognition model, to obtain prediction text content and corresponding prediction type tags output by the basic recognition model.

The sixth obtaining unit 460 is configured to modify the basic recognition model based on differences between the prediction text content and the second annotated text content, and differences between the prediction type tags and the second annotated type tags, to obtain the image recognition model corresponding to the target scene.

It is understood that, the apparatus 400 in FIG. 4 of the embodiment of the disclosure and the apparatus 300 in the above-mentioned embodiment, the first obtaining module 410 and the first obtaining module 310, the second obtaining module 420 and the second obtaining module 320, the third obtaining module 430 and the third obtaining module 330 may have the same function and structure.

It should be noted that the foregoing explanation of the embodiments of the method for training an image recognition model is also applicable to the apparatus for training an image recognition model of this embodiment, and its implementation principle is similar, which will not be repeated here.

In the embodiment of the disclosure, the training data set is obtained, and the training data set includes the first text images of each vertical category in the non-target scene, and the second text images of each vertical category in the target scene. The type of text content involved in the first text images is the same as the type of text content involved in the second text images. The basic recognition model is obtained by training the initial recognition model with the first text images. The image recognition model corresponding to the target scene is obtained by training the basic recognition model with the second text images. The target text images to be recognized are obtained. The target text images are parsed to determine the scene where the target text images are located. The target text images are input into the image recognition model corresponding to the scene, to obtain the text content involved in the target text images. When the basic recognition model is obtained by training, the initial recognition model is modified according to the differences between the prediction text content and the first annotated text content. When the image recognition model corresponding to the target scene is obtained by training, the basic recognition model is modified according to the differences between the prediction text content and the second annotated text content, and the differences between the prediction type tags and the second annotated type tags, so that the generated basic recognition model and image recognition model have high accuracy and great applicability, to accurately generate the corresponding text content according to the target text images.

According to the embodiments of the disclosure, the disclosure provides an electronic device, and a readable storage medium and a computer program product.

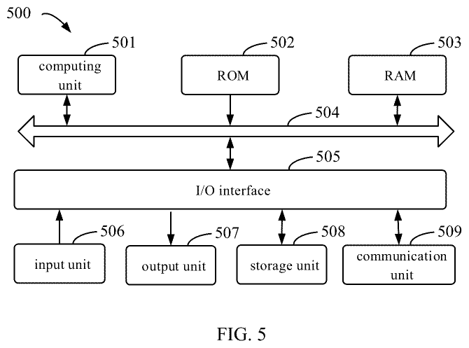

FIG. 5 is a block diagram of an example electronic device 500 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 5, the electronic device 500 includes: a computing unit 501 performing various appropriate actions and processes based on computer programs stored in a read-only memory (ROM) 502 or computer programs loaded from the storage unit 508 to a random access memory (RAM) 503. In the RAM 503, various programs and data required for the operation of the device 500 are stored. The computing unit 501, the ROM 502, and the RAM 503 are connected to each other through a bus 504. An input/output (I/O) interface 505 is also connected to the bus 504.

Components in the device 500 are connected to the I/O interface 505, including: an inputting unit 506, such as a keyboard, a mouse; an outputting unit 507, such as various types of displays, speakers; a storage unit 508, such as a disk, an optical disk; and a communication unit 509, such as network cards, modems, and wireless communication transceivers. The communication unit 509 allows the device 500 to exchange information/data with other devices through a computer network such as the Internet and/or various telecommunication networks.

The computing unit 501 may be various general-purpose and/or dedicated processing components with processing and computing capabilities. Some examples of computing unit 501 include, but are not limited to, a CPU, a graphics processing unit (GPU), various dedicated AI computing chips, various computing units that run machine learning model algorithms, and a digital signal processor (DSP), and any appropriate processor, controller and microcontroller. The computing unit 501 executes the various methods and processes described above, such as the method for training an image recognition model. For example, in some embodiments, the above method may be implemented as a computer software program, which is tangibly contained in a machine-readable medium, such as the storage unit 508. In some embodiments, part or all of the computer program may be loaded and/or installed on the device 500 via the ROM 502 and/or the communication unit 509. When the computer program is loaded on the RAM 503 and executed by the computing unit 501, one or more steps of the method described above may be executed. Alternatively, in other embodiments, the computing unit 501 may be configured to perform the method in any other suitable manner (for example, by means of firmware).

The embodiments of the disclosure provide a computer program product. When the computer programs in the product are executed by a processor, the method for training an image recognition model in the above-mentioned embodiments is implemented. In some embodiments, when the instructions in the computer program product are executed by a processor, the above-described method is implemented.

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user may interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a block-chain.

In the embodiment of the disclosure, the training data set is obtained, and the training data set includes the first text images of each vertical category in the non-target scene, and the second text images of each vertical category in the target scene. The type of text content involved in the first text images is the same as the type of text content involved in the second text images. The basic recognition model is obtained by training the initial recognition model with the first text images. The image recognition model corresponding to the target scene is obtained by training the basic recognition model with the second text images. Therefore, when the image recognition model in the target scene is obtained by training, a recognition model that may be applied to different vertical categories of the target scene is obtained by training with text images of different vertical categories of a scenes similar to the target scene, and text images of different vertical categories in the target scene, which improves the recognition accuracy and versatility of the model, reduces the memory occupied by the model, and saves labor costs and material costs.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the principle of this application shall be included in the protection scope of this application.

1. A method for training an image recognition model, comprising:
obtaining a training data set, wherein the training data set comprises first text images of each vertical category in a non-target scene and second text images of each vertical category in a target scene, and a type of text content involved in the first text images is the same as a type of text content involved in the second text images;
training an initial recognition model by using the first text images, to obtain a basic recognition model; and
modifying the basic recognition model by using the second text images, to obtain an image recognition model corresponding to the target scene.

2. The method of claim 1, wherein the training data set further comprises third text images in any scene.

3. The method of claim 1, wherein the training data set further comprises for each of the first text images, first annotated text content and location information of first text boxes, and training the initial recognition model by using the first text images, to obtain the basic recognition model, comprises:
obtaining first target images to be recognized from the first text images based on the location information of first text boxes;
inputting the first target images into the initial recognition model, to obtain first prediction text content output by the initial recognition model; and
modifying the initial recognition model based on differences between the first prediction text content and the first annotated text content, to obtain the basic recognition model.

4. The method of claim 3, wherein the training data set further comprises first annotated type tags corresponding to the first annotated text content, and
inputting the first target images into the initial recognition model, to obtain the first prediction text content output by the initial recognition model, comprises:
inputting the first target images into the initial recognition model, to obtain the first prediction text content and first prediction type tags output by the initial recognition model; and
modifying the initial recognition model based on the differences between the first prediction text content and the first annotated text content, to obtain the basic recognition model, comprises:
modifying the initial recognition model based on the differences between the first prediction text content and the first annotated text content, and differences between the first prediction type tags and the first annotated type tags, to obtain the basic recognition model.

5. The method of claim 1, wherein the training data set further comprises for each of the second text images, second annotated text content, location information of second text boxes, and second annotated type tags corresponding to the second annotated text content, and modifying the basic recognition model by using the second text images, to obtain the image recognition model corresponding to the target scene, comprises:
obtaining second target images to be recognized from the second text images based on the location information of second text boxes;
inputting the second target images into the basic recognition model, to obtain second prediction text content and second prediction type tags output by the basic recognition model; and
modifying the basic recognition model based on differences between the second prediction text content and the second annotated text content, and differences between the second prediction type tags and the second annotated type tags, to obtain the image recognition model corresponding to the target scene.

6. The method of claim 5, further comprising:
obtaining target text images to be recognized;
parsing the target text images, to determine a scene where the target text images are located; and
inputting the target text images into an image recognition model corresponding to the scene where the target text images are located, to obtain text content involved in the target text images.

7.-12. (canceled)

13. An electronic device, comprising:
at least one processor; and
a memory communicatively coupled to the at least one processor;
wherein, the memory stores instructions executable by the at least one processor, when the instructions are executed by the at least one processor, the at least one processor is caused to implement a method for training an image recognition model, the method comprising:
obtaining a training data set, wherein the training data set comprises first text images of each vertical category in a non-target scene and second text images of each vertical category in a target scene, and a type of text content involved in the first text images is the same as a type of text content involved in the second text images;
training an initial recognition model by using the first text images, to obtain a basic recognition model; and
modifying the basic recognition model by using the second text images, to obtain an image recognition model corresponding to the target scene.

14. A non-transitory computer-readable storage medium having computer instructions stored thereon, wherein the computer instructions are configured to cause a computer to implement a method for training an image recognition model, the method comprising:
obtaining a training data set, wherein the training data set comprises first text images of each vertical category in a non-target scene and second text images of each vertical category in a target scene, and a type of text content involved in the first text images is the same as a type of text content involved in the second text images;
training an initial recognition model by using the first text images, to obtain a basic recognition model; and
modifying the basic recognition model by using the second text images, to obtain an image recognition model corresponding to the target scene.

15. (canceled)

16. The electronic device of claim 13, wherein the training data set further comprises third text images in any scene.

17. The electronic device of claim 13, wherein the training data set further comprises for each of the first text images, first annotated text content and location information of first text boxes, and the at least one processor is further caused to implement:
obtaining first target images to be recognized from the first text images based on the location information of first text boxes;
inputting the first target images into the initial recognition model, to obtain first prediction text content output by the initial recognition model; and
modifying the initial recognition model based on differences between the first prediction text content and the first annotated text content, to obtain the basic recognition model.

18. The electronic device of claim 17, wherein the training data set further comprises first annotated type tags corresponding to the first annotated text content, and the at least one processor is further caused to implement:
inputting the first target images into the initial recognition model, to obtain the first prediction text content and first prediction type tags output by the initial recognition model; and
modifying the initial recognition model based on the differences between the first prediction text content and the first annotated text content, and differences between the first prediction type tags and the first annotated type tags, to obtain the basic recognition model.

19. The electronic device of claim 13, wherein the training data set further comprises for each of the second text images, second annotated text content, location information of second text boxes, and second annotated type tags corresponding to the second annotated text content, and the at least one processor is further caused to implement:
obtaining second target images to be recognized from the second text images based on the location information of second text boxes;
inputting the second target images into the basic recognition model, to obtain second prediction text content and second prediction type tags output by the basic recognition model; and
modifying the basic recognition model based on differences between the second prediction text content and the second annotated text content, and differences between the second prediction type tags and the second annotated type tags, to obtain the image recognition model corresponding to the target scene.

20. The electronic device of claim 19, wherein the at least one processor is further caused to implement:
obtaining target text images to be recognized;
parsing the target text images, to determine a scene where the target text images are located; and
inputting the target text images into an image recognition model corresponding to the scene where the target text images are located, to obtain text content involved in the target text images.

21. The storage medium of claim 14, wherein the training data set further comprises third text images in any scene.

22. The storage medium of claim 14, wherein the training data set further comprises for each of the first text images, first annotated text content and location information of first text boxes, and training the initial recognition model by using the first text images, to obtain the basic recognition model, comprises:
obtaining first target images to be recognized from the first text images based on the location information of first text boxes;
inputting the first target images into the initial recognition model, to obtain first prediction text content output by the initial recognition model; and
modifying the initial recognition model based on differences between the first prediction text content and the first annotated text content, to obtain the basic recognition model.

23. The storage medium of claim 22, wherein the training data set further comprises first annotated type tags corresponding to the first annotated text content, and
inputting the first target images into the initial recognition model, to obtain the first prediction text content output by the initial recognition model, comprises:
inputting the first target images into the initial recognition model, to obtain the first prediction text content and first prediction type tags output by the initial recognition model; and
modifying the initial recognition model based on the differences between the first prediction text content and the first annotated text content, to obtain the basic recognition model, comprises:
modifying the initial recognition model based on the differences between the first prediction text content and the first annotated text content, and differences between the first prediction type tags and the first annotated type tags, to obtain the basic recognition model.

24. The storage medium of claim 14, wherein the training data set further comprises for each of the second text images, second annotated text content, location information of second text boxes, and second annotated type tags corresponding to the second annotated text content, and modifying the basic recognition model by using the second text images, to obtain the image recognition model corresponding to the target scene, comprises:
obtaining second target images to be recognized from the second text images based on the location information of second text boxes;
inputting the second target images into the basic recognition model, to obtain second prediction text content and second prediction type tags output by the basic recognition model; and
modifying the basic recognition model based on differences between the second prediction text content and the second annotated text content, and differences between the second prediction type tags and the second annotated type tags, to obtain the image recognition model corresponding to the target scene.

25. The storage medium of claim 24, wherein the method further comprises:
obtaining target text images to be recognized;
parsing the target text images, to determine a scene where the target text images are located; and
inputting the target text images into an image recognition model corresponding to the scene where the target text images are located, to obtain text content involved in the target text images.
